(19) United States
(12) Patent Application Publication
(10) Pub. No.: US 2009/0295831 A1
(43) Pub. Date: Dec. 3, 2009

(54) IMAGE DISPLAY APPARATUS AND DISPLAY SYSTEM

(75) Inventor: Michihisa Yanagi, Utsunomiya-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/473,994

(22) Filed: May 28, 2009

(30) Foreign Application Priority Data
May 30, 2008 (JP) 2008-143831

(51) Int. Cl. G09G 5/00

(52) U.S. Cl. 345/643

(57) ABSTRACT

An image display apparatus includes a display device configured to display an image, a signal converter configured to provide a transformation process using transformation parameter information for an input image signal, and to generate a driving signal used to drive the display device, and a memory configured to store the transformation parameter information, the transformation parameter information being editable in a parameter editing apparatus that can communicate with the image display apparatus, wherein the memory stores the transformation parameter information edited by the parameter editing apparatus, and editing information of edited transformation parameter information used to reproduce the edited transformation parameter information in the parameter editing apparatus.

### BACKGROUND OF THE INVENTION

1. Field of the Invention

The present invention relates to an image display apparatus configured to generate a driving signal of a display device by performing a transformation processing for an input image signal, such as a gamma correction and an uneven color correction, or to display an output image.

2. Description of the Related Art

An image display apparatus, such as a projector or a monitor, includes a gamma corrector configured to provide a gamma correction. The gamma corrector is a circuit configured to correct a gamma characteristic of 1.0/2.2 (sometimes 1.0/1.8) that is previously set to a video (image) signal input to the image display apparatus or a VT (VR) characteristic of a liquid crystal panel.

A variety of gamma correction curves (gamma transformation parameters) can often be set to the gamma corrector in addition to the above gamma correction curve used to correct the above characteristic, such as a sRGB gamma correction curve configured to precisely reproduce sRGB or a brightness priority gamma correction curve that uses up to a maximum transmittance or maximum reflectance of the liquid crystal panel.

Some image display apparatuses allow a user to arbitrarily edit the gamma correction curve, and thereby display an image in accordance with a gamma characteristic preferred by the user. For instance, Japanese Patent No. 3,813,568 discloses an image display apparatus configured to edit a gamma correction curve used to correct a gamma characteristic on the brightness basis.

Few image display apparatuses allow a user to edit a gamma correction curve corresponding to a register form of a gamma corrector, but allow the user to edit the gamma correction curve after transforming the gamma correction curve in a LUT (look-up table) form etc. corresponding to a gamma corrector into a gamma correction curve expressed by a divisional polynomial curve like a spline curve. The edited gamma correction curve is retransformed into the LUT form, and stored in a nonvolatile memory such as an EEPROM. The gamma corrector corrects gamma by referring to the edited gamma correction curve stored in the nonvolatile memory.

A real-time operation of a spline curve is an overload for a built-in CPU in many of the image display apparatuses each of which allows a user to edit a gamma correction curve. Therefore, they often allow the user to edit the gamma correction curve through a personal computer (“PC”).

The gamma correction curve edited by the user with the PC is transformed into a register form or a form close to the register form of the gamma corrector of the image display apparatus when the gamma correction curve is written in the nonvolatile memory of the image display apparatus. At this time, user editing information of the gamma correction curve such as editing information at a spline node position may be deleted. In this case, the PC initializes a gamma correction curve different from the previously edited gamma correction curve, such as a default gamma correction curve that is linear to the brightness, in reediting or fine adjusting the gamma correction curve. It is thus difficult to reedit or fine-tune a gamma correction curve.

### SUMMARY OF THE INVENTION

The present invention provides an image display apparatus configured to easily reedit or make fine adjustments to a transformation parameter, such as a gamma correction parameter, and a display system using the same.

An image display apparatus according to one aspect of the present invention includes a display device configured to display an image, a signal converter configured to provide a transformation process using transformation parameter information for an input image signal, and to generate a driving signal used to drive the display device, and a memory configured to store the transformation parameter information, wherein the transformation parameter information is editable in a parameter editing apparatus that can communicate with the image display apparatus, and wherein the memory stores the transformation parameter information edited by the parameter editing apparatus, and editing information of edited transformation parameter information used to reproduce the edited transformation parameter information in the parameter editing apparatus.

An image display system that includes the above image display apparatus and a parameter editing apparatus constitutes one aspect of the present invention.

Further features of the present invention will become apparent from the following description of exemplary embodiments (with reference to the attached drawings).

### BRIEF DESCRIPTION OF THE DRAWINGS

FIG. 1 is a structural block diagram of an image display system that includes a projector and a PC according to one embodiment of the present invention.

FIG. 2 shows display windows and their transitions in accordance with an image gamma editing program in the PC according to the embodiment.

FIG. 3 is a flowchart of an image gamma reading process in the projector according to the embodiment.

FIG. 4 is a flowchart of an image gamma updating process in the projector according to the embodiment.

### DESCRIPTION OF THE EMBODIMENTS

Referring now to the accompanying drawings, a description will be given of the embodiment of the present invention.

In the embodiment of the present invention, a description will be given of an image display system that includes a liquid crystal projector as an image display apparatus and a PC as a parameter editing apparatus.

This embodiment provides a user with a comfortable operating environment by making the PC perform an overload processing, such as a real-time operation of a spline curve, when the operational processing ability of a CPU in the projector cannot perform that processing. This embodiment stores image gamma information that is user-edited transformation parameter information, in the nonvolatile memory in the projector. Conventionally, when editing information, such as a spline node position, is deleted by closing an application in a PC after the image gamma information is edited, the PC cannot reproduce the edited image gamma information. On the other hand, this embodiment can read out the editing information stored in the nonvolatile memory of the projector, and reproduce the image gamma information edited in the PC. Thus, this reproduced edited image gamma information is used as an initial value for reediting and fine adjustment of the image gamma information.

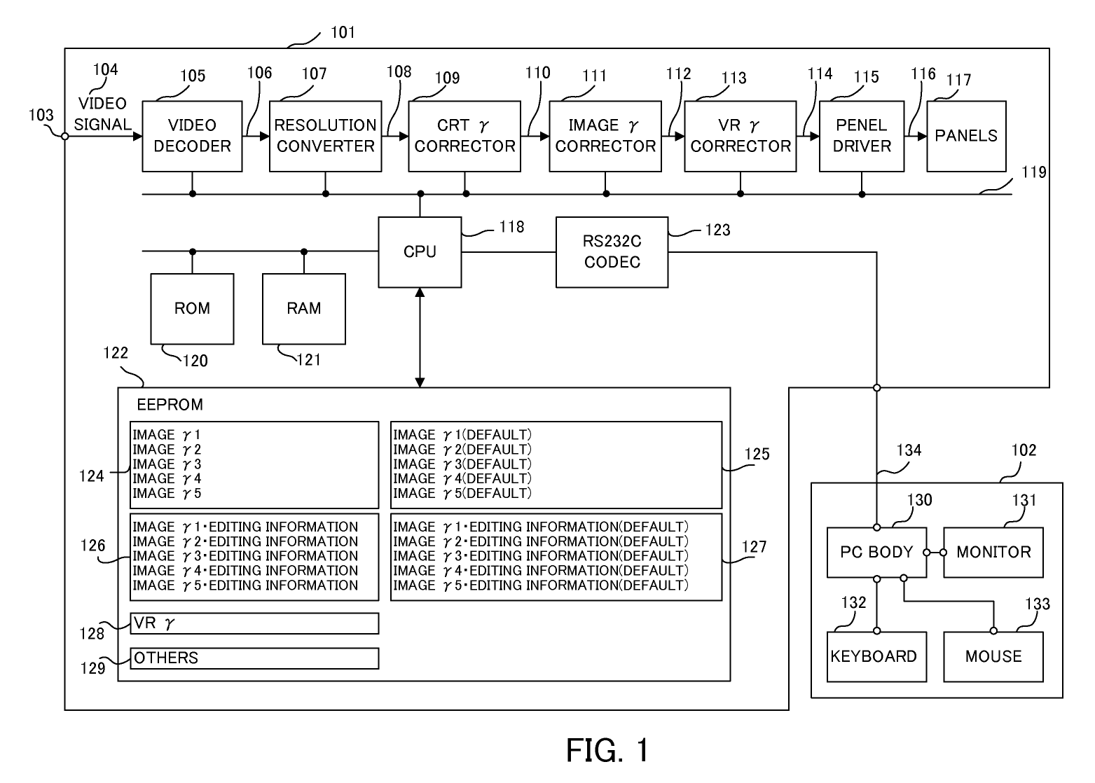

FIG. 1 shows an overall structure of the image display system according to this embodiment. In this embodiment, a rewritable nonvolatile memory 122 provided in the projector 101 stores the image gamma information (transformation parameter information) corresponding to the register form of the gamma corrector which will be described later. The nonvolatile memory 122 also stores editing information (shown as image gamma N editing information in the figure) on the image gamma information edited by the user using the PC as the parameter editing apparatus. The editing information is not used exclusively for the projector, and is saved so as to provide information at a spline node position etc. in editing the image gamma with a spline curve on the PC.

The video signal (image signal) supplied from a video signal generator source (not shown) is input into a projector 101 through a video signal connector 103 provided in the projector 101.

When an input video signal 104 is a video signal in an YCrCb form, a video decoder 105 transforms it into a video signal 106 in a digital RGB form (“digital RGB signal” hereinafter).

At this stage, there is no guarantee that the digital RGB signal 106 has the same resolution as the resolution of three liquid crystal panels 117 (which are assumed to be reflective liquid crystal panels and simply referred to as “panels” hereinafter) as a display device provided for three colors R, G, and B. Therefore, there is no correspondence between pixels on the panels 117 and the video signal. Accordingly, a digital RGB signal 108 corresponding to the resolution of the panel 117 is generated by expanding and reducing the digital RGB signal 106 by using a resolution converter 107.

The digital RGB signal 108 through the resolution converter 107 is a normalized signal to an image size, but does not have a linear characteristic to a digital value of the pixel and a reflectance of the panel, because no CRT gamma, such as 1.0/2.2 (or 1.0/1.8), has not yet been provided in a transmission course to the projector 101. A CRT gamma corrector 109 is a circuit configured to convert a tone value so that the reflectance has a linear relationship with a tone value of the digital RGB signal 108.

The above process provides a digital RGB signal 110 in which both resolution and reflectance are normalized. A process of a circuit subsequent to an image gamma corrector 111 normalizes the panel's VR characteristic of the panel (a reflectance characteristic to the driving voltage applied to the panel). In other words, even if there is no image gamma corrector 111, an image can be projected while a tone intended in an input video signal is maintained from the minimum reflectance to the maximum reflectance of three panels provided for R, G, and B (also referred to as RGB panels).

However, a lamp (not shown) as a light source in the projector 101, a characteristic of an optical element (not shown) in an optical system, and a maximum reflectance for each RGB panel scatter. Thus, even if each of the RGB panels is set to the maximum reflectance, a white image is not necessarily projected and a greenish raster, for example, is projected. Of course, when an input video signal is sRGB, chromaticity of D60 (x=0.313, y=0.329) is ideal. It is also conceivable that there may be a demand for bluish chromaticity of a low tone in a design of the projector.

In order to satisfy this demand, an image gamma corrector 111 provides an arbitrary gamma correction (gamma transformation processing) to the digital RGB signal 110 that has a linear characteristic with respect to the tone and the reflectance.

In order to project an image while a tone expression of a digital RGB signal 112 is maintained which has been transformed into a tone expression ideal or in accordance with a user's preference by the image gamma corrector 111, it is necessary to normalize a VR characteristic and to provide such a correction that the reflectance has a linear relationship with the tone. A VR gamma corrector 113 is a circuit configured to provide this tone transformation.

A digital RGB signal 114 output from the VR gamma corrector 113 includes a digital value and a synchronous signal used to control a driving voltage applied to the panels. A panel driver 115 generates from the digital RGB signal 114 a panel driving signal 116 that includes an analogue signal and a synchronous signal used to drive the panels, and drives the panels 117.

The processing flow to generate the driving signal that drives the panels based on the input video signal is thus described. The video decoder 105, the resolution converter 107, the CRT gamma corrector 109, the image gamma corrector 111, the VR gamma corrector 113, and the panel driver 115 (particularly from the image gamma corrector 111 to the panel driver 115) correspond to a signal converter.

The circuits from the video decoder 105 to the VR gamma corrector 113, the panel driver 115, the panels 117, and a CPU 118 are connected to an IIC bus 119, and the CPU 118 can change register settings for each circuit.

The CPU 118 is connected to a ROM 120 that stores an instruction to control the projector 101, and a RAM 121 that temporarily stores a stack, a variable, or a program code and is referred to in running the program. The CPU 118 is connected to an EEPROM 122 as a nonvolatile memory that rewritably stores default data of the projector 101 or an internal counter of the projector 101, or the like. The CPU 118 is connected to an RS232C codec 123 configured to control the projector 101 from an external apparatus, such as the PC.

The EEPROM 122 rewritably stores (memorizes) image gamma N information (N=1, 2, 3 . . . ) 124 as transformation parameter information to be set to the image gamma corrector 111 in starting the projector 101 or in changing an image mode. The image gamma N information 124 may be either in a LUT form or in a spline form.

The EEPROM 122 also stores default image gamma N information 125 for backup when the outside PC 102 rewrites the image gamma N information.

The EEPROM 122 also stores image gamma N editing information 126 as editing information relative to edited image gamma N that can be read by the PC 102.

The EEPROM 122 also stores default image gamma N editing information 127, VR gamma information 128 as setup information on the VR gamma corrector 113 used to linearly correct the VR characteristic of the panels 117, and other information 129 as storage information such as a counter.

The PC 102 includes a PC body 130 that includes a CPU, a hard disk drive, and a memory, a monitor 131, a keyboard 132, and a mouse 133.

In this image display system, a user can edit image gamma N information using an image gamma editing program stored in the PC body 130 through the PC 102.

A description will now be given of editing of the image gamma N information 124 for the first time from the default state of the projector 101. The PC 102 (or the PC body 130) reads the image gamma N editing information 126 including a spline node position etc. of the image gamma N information 124 by communicating with the CPU 118 in the projector 101 connected with the RS232C cable 134. The PC 102 reproduces image gamma N information in a spline form corresponding to the image gamma N information 124 based on the read image gamma N editing information 126, and displays it on the monitor 131. Thereby, the user can edit image gamma N information with the PC 102 while confirming it on the monitor 131.

When editing ends, the PC 102 communicates with the CPU 118, and overwrites (rewrites) the original image gamma N information 124 in the EEPROM 122 with edited image gamma N information. The PC 102 writes in the EEPROM 122 image gamma N editing information that includes information of a spline node position etc. specified at the editing time of the current image gamma N information. The PC 102 may overwrite default image gamma N editing information 126 with the current image gamma N editing information.

A description will now be given of reediting or fine-adjusting the previously edited image gamma N information 124. The PC 102 (PC body 130) communicates with the CPU 118, and reads image gamma N editing information 126 to the previously edited image gamma N information 124. The PC 102 displays on the monitor 131 the image gamma N information reproduced in the spline form based on the read image gamma N editing information 126. The user can reedit or fine-adjust this image gamma N information based on the previously edited, reproduced, or displayed image gamma N information.

When reediting or fine adjustment ends, the PC 102 communicates with the CPU 118, and overwrites the previously edited image gamma N information 124 in the EEPROM 122 with the currently reedited image gamma N information. The PC 102 overwrites the previously edited image gamma N editing information 126 with image gamma N editing information including information of a spline node position etc. specified at the editing time of the current image gamma N information.

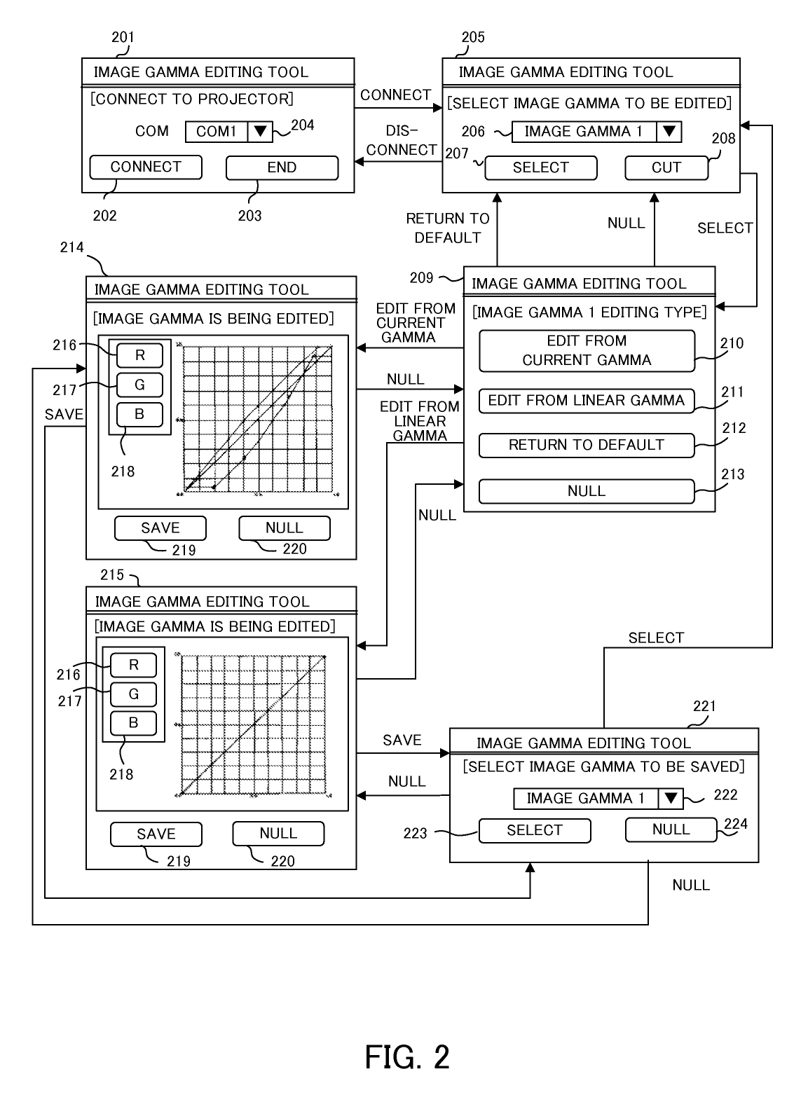

FIG. 2 shows a display transition on the monitor 131 by the above image gamma editing program (image gamma editing tool).

During an operation of the image gamma editing program, whenever the image gamma N information is edited, the register in the image gamma corrector 111 is updated, and a video signal input to the projector 101 is gamma-corrected.

After the program is started, a “connect to projector” window 201 opens on the monitor 131. COM port number connected with the projector 101 can be selected by operating a “COM” button 204 in the window 201. A “connect” button 202 used to start a communication with the projector 101 and an “end” button 203 used to end a communication can be operated. The button can be operated by left-clicking the mouse 133.

When the “connect” button 202 is operated, the program communicates with the projector 101 and determines whether the projector 101 is a model compatible with this program or (can be connected).

If the projector 101 is connectable, the program displays a “select image gamma to be edited” window 205 on the monitor 131. On the other hand, if the projector 101 is not connectible, the program displays that information on the monitor 131 and again displays a “connect to projector” window 201. When the “end” button 203 is operated in the “connect to projector” window 201, this program is ended.

In the “select image gamma to be edited” window 205, a “select” button 207 and a “cut” button 208 can be operated while an “image gamma N” button 206 selects image gamma N information in the EEPROM 122. Assume that this embodiment stores five pieces of image gamma N information 124 (N=1-5) in the EEPROM 122. Therefore, the “image gamma N” button 206 can select one of image gamma 1 to image gamma 5. The “select” button 207 is operated in instructing editing of the image gamma N information selected by the “image gamma N” button 206.

Next follows a description when it is assumed that the image gamma 1 information is selected. When the image gamma 1 information is selected, the program displays an “image gamma 1 editing type” window 209 on the monitor 131.

When the “cut” button 208 is selected in the “select image gamma to be edited” window 205, the program again displays the “connect to projector” window 201 on the monitor 131.

In the “image gamma 1 editing type” window 209, an editing type to the currently selected image gamma 1 information in the EEPROM 122 can be selected, by operating four buttons, i.e., an “edit from current gamma” button 210, an “edit from linear gamma” button 211, a “return to default” button 212, and a “null” button 213.

When the “edit from current gamma” button 210 is operated, the program reads image gamma 1 editing information 126 stored in the EEPROM 122, and reproduces image gamma 1 information in the spline form based on the image gamma 1 editing information 126. The program displays an “image gamma is being edited” window 214 to display image gamma 1 information in the spline form reproduced in the window 214.

When the “edit from linear gamma” button 211 is operated, the program displays an “image gamma is being edited” window 215 on the monitor 131. The program displays linear image gamma information that is set so that the reflectance of panels 117 can have a proportional relationship with an input tone in the window 215 in the spline form. More specifically, the program automatically sets a spline node position representative of a minimum reflectance of the panels 117 to a minimum input tone, and a spline node position representative of a maximum reflectance of the panels 117 to a maximum minimum input tone, and displays them after connecting them with each other via a line.

When the “return to default” button 212 is operated, the program overwrites currently selected image gamma 1 information 124 in the EEPROM 122 with the default image gamma 1 information 125 stored in the EEPROM 122. The program overwrites the image gamma 1 editing information 126 corresponding to the image gamma 1 information 124 with default image gamma 1 editing information 127 stored in the EEPROM 122. Thus, the program returns the program returns image gamma 1 information 124 to the default image gamma 1 information. Thereafter, the program displays the “select image gamma to be edited” window 205 on the monitor 131.

When the “null” button 213 is operated, the program displays the “select image gamma to be edited” window 205 on the monitor 131 without doing anything.

Since only the initially displayed image gamma information as an object to be edited is different between the “image gamma is being edited” window 214 and the “image gamma is being edited” window 215, as described above, the same editing operation can be performed basically.

An “R” button 216, a “G” button 217, and a “B” button 218 are buttons used to select one of R, G, and B as a color of image gamma information (image gamma 1 information or linear image gamma information) to be edited.

When one of R, G, and B is selected, the program enables the image gamma information (spline curve) to be edited using the mouse 133. More specifically, for example, when a cursor of the mouse is set to a point on or near a spline curve and the mouse is left-clicked, the spline curve is dragged and changed.

The program overwrites image gamma 1 information stored in the EEPROM 122 with information of a changing spline curve or edited image gamma information. An update of the image gamma 1 information is reflected in the gamma correction in the image gamma corrector 111 in the projector 101, and the tone expression by the projected image is changed.

The program overwrites the image gamma 1 editing information 126 stored in the EEPROM 122 with editing information including information of a spline node position which changes in accordance with a change of the spline curve.

As the spline curve is frequently changed, it is conceivable that the image gamma information and editing information corresponding to the previously changed spline curve are being transmitted to the projector. In this case, a transmission standby buffer that will be used for the next transmission may temporarily store the image gamma information and editing information, separate from a transmission buffer used for a transmission at that time.

As other editing functions available with the “image gamma is being edited” windows 214 and 215, for example, a node can be newly added to a left-clicked position when the mouse's left-click and the shift key of the keyboard 132 are operated at the same time. A node near the left-clicked position can also be deleted by the right click and shift key operations.

In the “image gamma is being edited” windows 214 and 215, the “save” button 219 and the “null” button 220 can be operated. When the “save” button 219 is operated, the program displays “select image gamma to be saved” window 221 on the monitor 131.

In the “select image gamma to be saved” window 221, a “select” button 223 and a “null” button 224 can be operated. When the “select” button 223 is operated, image gamma N information of a number selected by an “image gamma N” selection button 222 among the image gamma N information stored in the EEPROM 122 is overwritten with currently edited image gamma information. After overwriting, the program displays the “select image gamma to be edited” window 205 on the monitor 131.

When the “null” button 224 is operated, the program again displays the “image gamma is being edited” windows 214 and 215, and allows editing of the image gamma information to be resumed from the state just before the “save” button 219 is operated in the windows 214 and 215.

When the “null” button 220 is selected in the “image gamma is being edited” windows 214 and 215, the program annuls the previously edited image gamma information, and displays the “image gamma 1 editing type” 209 on the monitor 131.

An operation of the image gamma editing program in the PC is thus described.

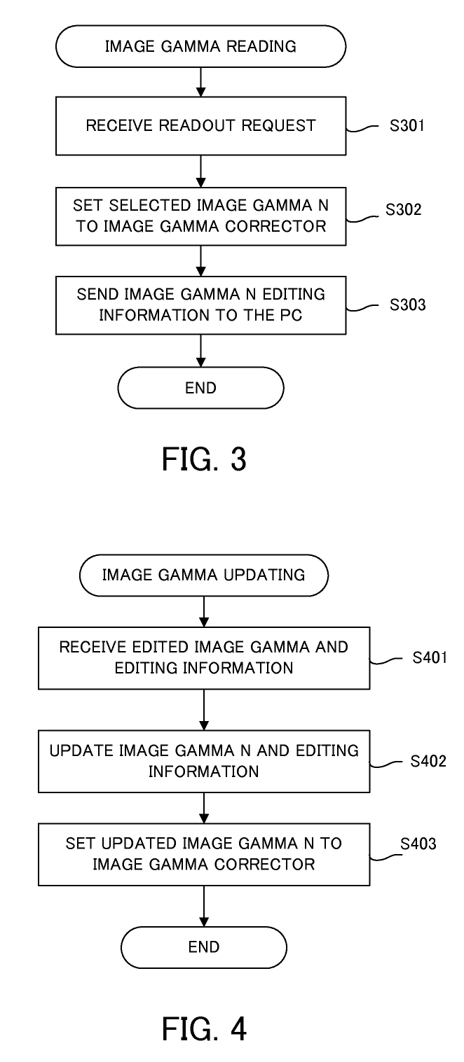

FIG. 3 is a flowchart of an image gamma reading process performed by the CPU 118 in the projector 101 when the PC starts editing the image gamma.

When the PC 102 is started, the CPU 118 of the projector 101 receives a readout request from the PC 102 (step S301). This readout request is a command that requests readout of the image gamma N information 124 corresponding to the number selected by the PC 102 from among the EEPROM 122.

In order to respond to this request, the CPU 118 reads the image gamma N information 124 corresponding to the number selected by the PC 102 out of the EEPROM 122, and sets it to the image gamma corrector 111 (step S302). If the data form can be read by the image gamma corrector 111 is a LUT form, the image gamma N information set to image gamma corrector 111 is also a LUT form. If the data form that can be read by the image gamma corrector 111 is a spline form, the image gamma N information set to the image gamma corrector 111 is also a spline form.

Thereafter, the CPU 118 reads out of the EEPROM 122 the image gamma N editing information 126 corresponding to the image gamma N information 124 corresponding to the number selected by the PC 102, and sends it to the PC 102 (step S303). This flow ends after the transmission ends.

FIG. 4 is a flowchart showing an image gamma updating process performed by the CPU 118 in the projector 101 when the PC 102 is editing the image gamma and when the PC 102 completes editing of the image gamma.

When the image gamma information is edited in the PC 102, the image gamma N information set to the image gamma corrector 111 is updated in response.

When the image gamma information is edited in the PC 102, the CPU 118 receives the edited image gamma information sent from the PC 102 and corresponding editing information (step S401).

The CPU 118 overwrites (updates) the image gamma N information 124 and image gamma N editing information 126 stored in the EEPROM 122 with received image gamma information and editing information (step S402).

The CPU 118 sets the overwritten image gamma N information 124 to the image gamma corrector 111 (step S403). If the data form that can be read by the image gamma corrector 111 is a LUT form, the image gamma N information set to the image gamma corrector 111 is also an LUT form. If the data form that can be read by the image gamma corrector 111 is a spline form, the image gamma N information set to the image gamma corrector 111 is also a spline form. Thereafter, this sequence is ended.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions

The above embodiment uses a gamma correction as a transformation process, and a gamma transformation parameter (image gamma information) for a gamma correction as transformation parameter information. However, the transformation process and the transformation parameter information according to the present invention are limited to them. For instance, the present invention is applicable to an image display apparatus that provides an uneven color correction as a transformation process, and a color transformation parameter as transformation parameter information.

While the above embodiment describes a projector, the present invention is applicable to a variety of display apparatuses other than the projector.

This application claims the benefit of Japanese Patent Application No. 2008-143831, filed May 30, 2008, which is hereby incorporated by reference herein in its entirety.

What is claimed is:

1. An image display apparatus comprising:
a display device configured to display an image;
a signal converter configured to provide a transformation process using transformation parameter information for an input image signal, and to generate a driving signal used to drive the display device; and
a memory configured to store the transformation parameter information,
wherein the transformation parameter information is editable in a parameter editing apparatus that can communicate with the image display apparatus, and
wherein the memory stores the transformation parameter information edited by the parameter editing apparatus, and editing information of edited transformation parameter information used to reproduce the edited transformation parameter information in the parameter editing apparatus.

2. The image display apparatus according to claim 1, wherein the parameter editing apparatus reproduces the transformation parameter information in a spline form, and the editing information contains information of a node position of a curve in the spline form.

3. An image display system comprising:
an image display apparatus; and
a parameter editing apparatus configured to communicate with the image display apparatus,
wherein an image display apparatus includes:
a display device configured to display an image;
a signal converter configured to provide a transformation process using transformation parameter information for an input image signal, and to generate a driving signal used to drive the display device; and
a memory configured to store the transformation parameter information,
wherein the transformation parameter information is editable in a parameter editing apparatus that can communicate with the image display apparatus, and
wherein the memory stores the transformation parameter information edited by the parameter editing apparatus, and editing information of edited transformation parameter information used to reproduce the edited transformation parameter information in the parameter editing apparatus.
